(19) United States
(12) Patent Application Publication
(10) Pub. No.: US 2017/0219267 A1
(43) Pub. Date: Aug. 3, 2017

(54) PACKAGED FOOD PRODUCT

(71) Applicant: NESTEC S.A., Vevey (CH)

(72) Inventors: Joel Dean GENAW, JR., Hesperia, MI (US); Matthew Blake RODGERS, Grand Haven, MI (US); Barbara Burzinski HARTLIEP, Spring Lake, MI (US)

(21) Appl. No.: 15/421,811

(22) Filed: Feb. 1, 2017

Related U.S. Application Data
(60) Provisional application No. 62/289,530, filed on Feb. 1, 2016.

(51) Int. Cl. F25C 1/22; B65D 77/20; F25C 5/06; B65D 85/72; B65B 7/28; A23L 3/36; B65D 77/22

(52) U.S. Cl. CPC F25C 1/22; A23L 3/364; B65D 77/20; B65D 77/22; B65D 85/72; B65B 7/28; F25C 5/06; A23L 33/10

(57) ABSTRACT

A packaged food product, comprising a tray having a base portion and a plurality of spaced-apart deformable cup portions each having an opening through the base portion; a cover covering the openings of the cup portions and removably attached to the base portion, the cover rendable at each opening; and one or more freezable food product contained in the cup portions such that, when frozen, the food product is dischargeable from the cup portions through the cover when force is applied to deform the cup portions.

### CROSS REFERENCE TO RELATED APPLICATIONS/INCORPORATION BY REFERENCE STATEMENT

The subject application claims benefit under 35 USC §119(e) of provisional application U.S. Ser. No. 62/289,530, filed Feb. 1, 2016; the entire contents of which are expressly incorporated herein by reference.

### STATEMENT REGARDING FEDERALLY SPONSORED RESEARCH AND DEVELOPMENT

Not Applicable.

### BACKGROUND

According to the USDA, between 1978 and 2008 the average number of snacks consumed per day in the U.S. doubled, and the percentage of adults snacking on any given day rose from 59 to 90 percent. Snacks provide about one-fourth of daily calories, greater proportions of alcohol, carbohydrates and total sugars, and lesser proportions of most other nutrients. Overall, the foods and beverages contributing the most calories as snacks are not the most nutritious options.

Additionally, snacks may be packaged in unhealthy sized portions or in packaging that causes a user difficulty in dispensing a healthy sized portion. Ice-cube trays may be used to freeze foods into cubes. However, traditional ice-cube trays are open to contaminates and are not conveniently pre-packaged.

At the same time, various types of packaging for pharmaceutical products are well known in the art for dispensing individual components. For example, blister-pack type packaging may be used as packaging for a variety of medicines in pill or tablet form to allow consumers to easily dispense a specific number of pills having the appropriate level of a pharmaceutical. Typically, a blister-pack package may contain individually compartmentalized pills attached to one card. Blister-pack cards may also be known as “push-through” packs in which the pill is removed from the packaging by pushing the material of the compartment holding the pill to push the pill through the card.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a top perspective view of a packaged food product constructed in accordance with the inventive concepts disclosed herein.

FIG. 2 is a side elevational view of the packaged food product of FIG. 1.

FIG. 3 is a top perspective view of components of the packaged food product of FIG. 1.

FIG. 4 is a bottom perspective view of the packaged food product of FIG. 1 in use.

FIG. 5 is a perspective view of another embodiment of a packaged food product constructed in accordance with the inventive concepts disclosed herein.

FIG. 6 is a side elevational view of the packaged food product of FIG. 5.

FIG. 7 is a top plan view of the packaged food product of FIG. 5.

FIG. 8 is a perspective view of a plurality of a packaged food product constructed in accordance with the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments, or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof, are intended to cover a non-exclusive inclusion. For example, a process, method, article, or apparatus that comprises a list of elements is not necessarily limited to only those elements, and may include other elements not expressly listed or inherently present therein.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one and the singular also includes the plural unless it is obvious that it is meant otherwise.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

“Shelf-Stable food product” refers to food products that can be safely stored and sold in a sealed container at room temperature while still having a useful shelf life, for example at least about two months, or longer.

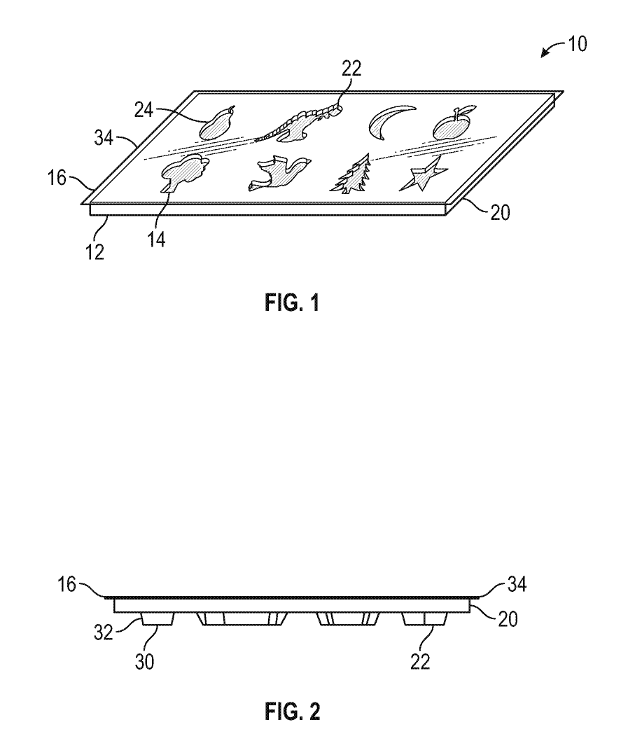

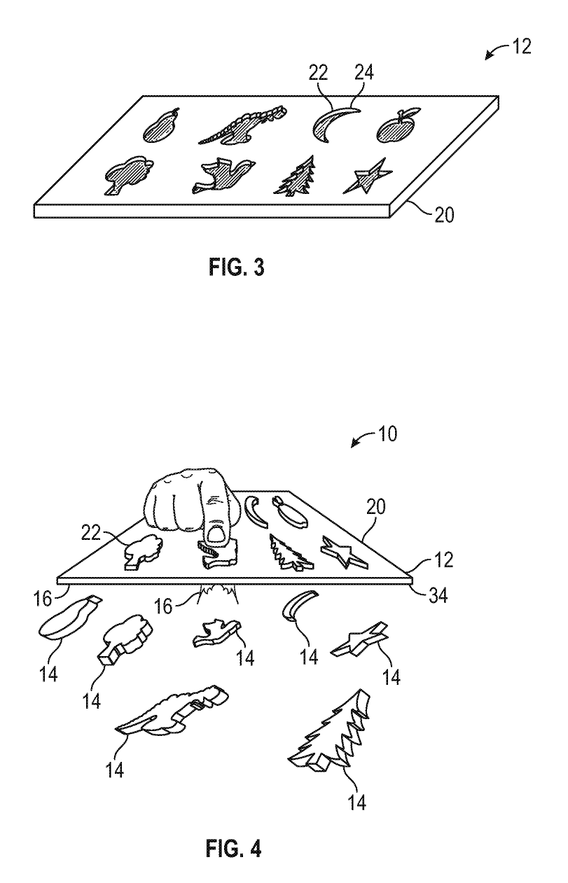

Referring now to the drawings, and in particular to FIGS. 1-4, a packaged food product 10 constructed in accordance with the inventive concepts disclosed herein is illustrated. The packaged food product 10 comprises a tray 12, one or more freezable food product 14 in the tray 12, and a cover 16 removably attached to the tray 12.

The tray 12 has a base portion 20 and a plurality of spaced-apart deformable cup portions 22 each having an opening 24 through the base portion 20. In one embodiment, the tray 12 may be thermo-formed.

The base portion 20 and the cup portions 22 may be made of the same material or different materials, In one embodiment, the base portion 20 is made of a material that is more rigid than the material of the cup portions 22, In some embodiments, the material from which the base portion 20 and/or the cup portions 22 are fabricated may be selected from one or more of materials in a group consisting of polyethylene terephthalate (PET), amorphous polyethylene terephthalate (APET), oriented polyethylene terephthalate (OPET), polyester (PE), low density polyester (LDPE), linear low density polyester (LLDPE), metalocene linear low density polyester (mLLDPE), high density polyester (HDPE), metalocene polyester (mPE), ethylene vinyl acetate (EVA), polypropylene (PP), high impact polystyrene (HIPS), foil, ethylene vinyl alcohol (EVOH), polyimide, Nylon, polyvinyl chloride (PVC), biaxially oriented materials, materials complying with 21 C.F.R. Part 177, nitrile, rubber, silicon, polyurethane, and combinations thereof. Where foil is used, that foil may be an aluminum foil, or other metal foil.

In one embodiment, the cup portions 22 are pliable such that the cup portions 22 can be deflected by squeezing with hand pressure, that is, pressure applied via fingers of an unaided human hand. The cup portions 22 may be sufficiently stiff that the cup portions 22 do not deform or deflect in the absence of force.

In one embodiment, one or more of the cup portions 22 has a bottom 30 and a sidewall 32 extending from the bottom 30 of the cup portion 22 to the base portion 20 of the tray 12 so as to cooperate to define a pouch 36 for containing the food product 14, such that the food product 14, when frozen, is dischargeable from the cup portion 22 through the cover 16 when force is applied to the bottom 30 of the cup portion 22 to deform the bottom 30 of the cup portion 22 toward the base portion 20 of the tray 12. In one embodiment, the bottom 30 may be stiffer than the sidewall 32, such that a force on the bottom 30 may be used to deform the sidewall 32 and push the frozen food product 14 through the cover 16.

In one embodiment, each of the cup portions 22 is of a size to contain the food product 14 in an amount substantially of one serving of a particular food group. For example, one or more of the cup portions 22 may be a size to contain an amount of the food product 14 substantially equal to one serving of vegetables, or one serving of fruit, or one serving of protein, or one serving of dairy, or one serving of grain, or one serving of fiber, or one serving of meat, and so on. In one embodiment, one or more of the cup portions 22 may be of a size to contain the food product 14 in an amount of a multiplier of a serving, such as two times a serving, one half a serving, three times a serving, one fourth a serving, and so on. In one embodiment, one or more of the cup portions 22 may be sized to contain a combination of servings of two or more different types of the food product 14. A “serving” may be a predetermined amount of the food product 14 of a particular type or category of food for a recommended diet, for example, as recommended by the United States Department of Agriculture.

In one embodiment, one or more of the cup portions 22 has a shape resembling one or more fruit, vegetable, meat, animal, character, toy, cylinder, cone, or 3D polygon, by way of example, such that when the food product 14 is frozen the food product 14 has a shape resembling the one or more fruit, vegetable, meat, animal, character, toy, cylinder, cone, or 3D polygon.

While FIGS. 1-4 illustrate the plurality of cup portions 22 being a quantity of twelve for exemplary purposes, the plurality of cup portions 22 may be two, three, four, or more cup portions 22. In one embodiment, the plurality of cup portions 22 is ten.

The cover 16 may be removably attached to the base portion 20 of the tray 12. The cover 16 covers the openings 24 of the cup portions 22. The cover 16 may be removable from one or more of the cup portions 22 at a time, The cover 16 may be removable in its entirety from the tray 12 at one time. The cover 16 is rendable at each opening 24 of the cup portions 22.

In one embodiment, the cover 16 at each opening 24 of the cup portions 22 may have a first thickness while the cover 16 at the base portion 20 may have a second thickness. The second thickness may be thicker than the first thickness. The first thickness may be of a size that may be torn, ruptured, or fractured with hand pressure, that is, pressure applied via fingers or thumb of an unaided human hand. In one embodiment, the thickness of the cover 16 may lie in a range of about 0.001 inch to about 0.005 inch. It will be understood that the cover 16 may have other thicknesses and/or varying thicknesses.

In one embodiment, the cover 16 at each opening of the cup portions 22 may be scored such that the thickness is partially cut through. The scoring decreases the force needed to tear, rupture, or fracture the cover 16 at each opening.

The scoring can be applied to the cover 16 before, during, or after assembly of the packaged food product 10. In one embodiment, a laser scoring process may be employed to apply the scoring.

In one embodiment, the cover 16 may include one or more tab portion 34 for gripping, which enables the cover 16 to be peeled away from the tray 12, either partially, or entirely. In one embodiment, the cover 16 is adhered to the base portion 20 of the tray 12, but the cover 16 has a non-bonded region on an edge, end, and/or corner of the tray 12 so as to form the one or more tab portion 34. The tab portion 34 may be sufficiently large to be graspable between a user's finger and thumb. For example, the tab portion 34 may have a graspable portion of about 0.5 inches or more. In one embodiment, the tab portion 34 is generally angular and/or aligned with a plane of symmetry of the cover 16. A user may utilize the tab portion 34 to initiate peeling the cover 16 away from the tray 12. The tab portion 34 reduces the necessary force to peel the cover 16 away from the tray 12. The tab portion 34 enhances the ease with which the cover 16 may be removed from the tray 12.

In one embodiment, the cover 16 is attached to the tray 12 with an adhesive in a manner that enables the cover 16 to be peeled away from a first part of the tray 12, while still maintaining adhesion to a second part of the tray 12, such as when a user discharges a plurality of the frozen food products 14 at a time without discharging all of the food products 14.

The cover 16 may be made of one or more materials from a group consisting of plastic laminates, of polyethylene terephthalate (PET), amorphous polyethylene terephthalate (APET), oriented polyethylene terephthalate (OPET), polyester (PE), low density polyester (LDPE), linear low density polyester (LLDPE), metalocene linear low density polyester (mLLDPE), high density polyester (HDPE), metalocene polyester (mPE), ethylene vinyl acetate (EVA), polypropylene (PP), high impact polystyrene (HIPS), foil, ethylene vinyl alcohol (EVOH), polyimide, Nylon, polyvinyl chloride (PVC), and combinations thereof. Where foil is used for the material of the cover 16, the foil may be an aluminum foil, or other metal foil.

While the cover 16 may comprise a single layer of the selected material, the cover 16 may also be fabricated of multiple layers bonded, co-extruded or otherwise formed together into a cohesive structure, where one or more of the layers is selected from the group of materials set forth above.

The cover 16 may be transparent, translucent, or opaque. The cover 16 may be colored.

Regardless of the particular composition used for the cover 16, surfaces of the cover 16 which face the food product 14 may be made of food-safe material, for example, as defined by the U.S. Food and Drug Administration. If the food product 14 is susceptible to oxygen degradation over time, the cover 16 may include an oxygen control layer or an oxygen scavenger layer. One suitable material for an oxygen control layer is ethylene vinyl alcohol (EVOH) which may function not only as an oxygen barrier but may also function as a moisture barrier.

The one or more freezable food product 14 may be contained in the cup portions 22 of the tray 12. When the food product 14 is frozen, the food product 14 is dischargeable from the cup portions 22 through the cover 16 when force is applied to deform the cup portions 22 of the tray 12.

In one embodiment, the freezable food product 14 is shelf-stable when unfrozen.

In one embodiment, the food product 14 contains one or more vegetable, fruit, meat, grain, protein, or dairy. In one embodiment, the food product 14 includes a fruit with pulp, In one embodiment, the food product 14 is one or more food product 14 selected from the group consisting of a puree, a yogurt, and a juice.

In one embodiment, the food product 14 may contain particulates. In one embodiment, the food product 14 may have a high viscosity. In one embodiment, the food product 14 may have a low viscosity.

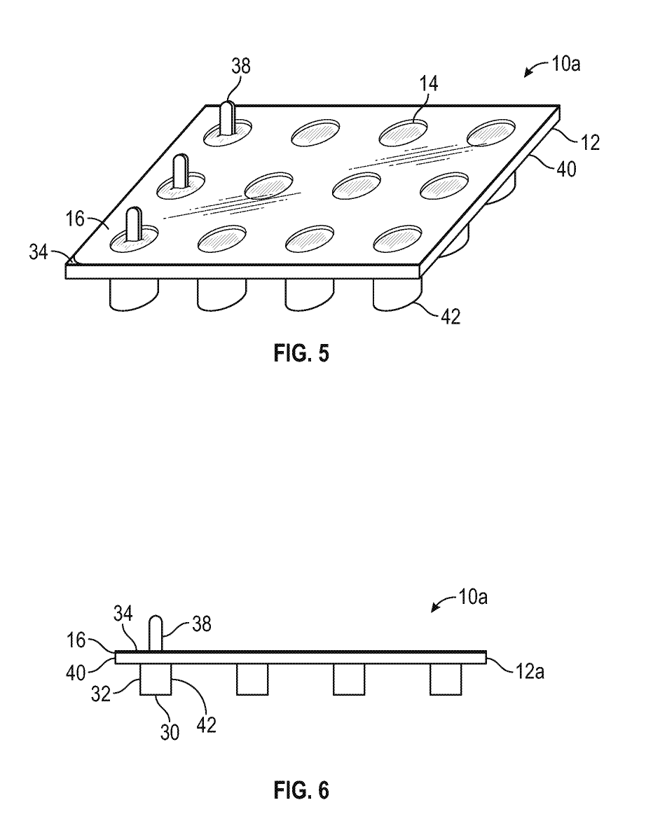

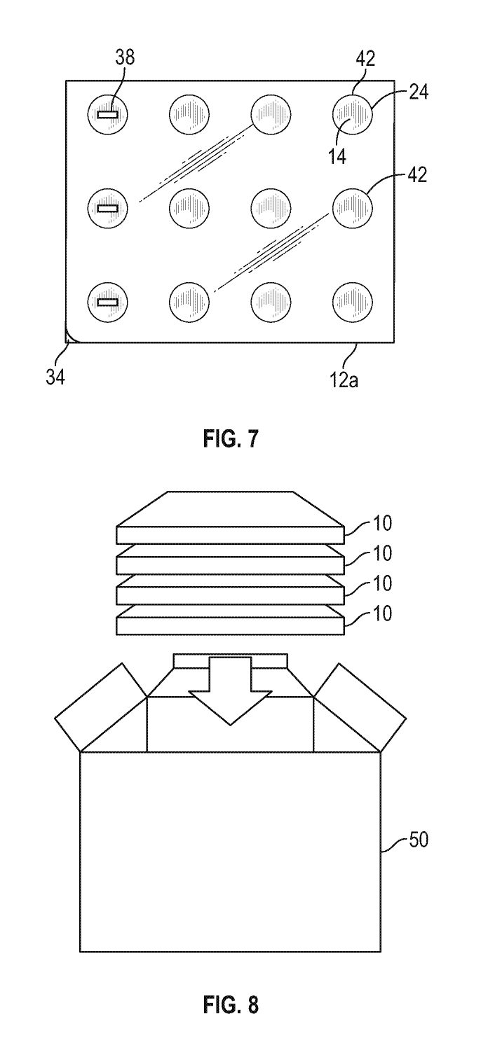

The packaged food product 10 may further comprise one or more handle 38 for the food product 14 (as shown in FIGS. 5-7).

FIGS. 5-7 illustrate another embodiment of a packaged food product 10a constructed in accordance with the inventive concepts disclosed herein. The packaged food product 10a is similar to the packaged food product 10 described above, except as described below. The packaged food product 10a includes a tray 12a, one or more freezable food product 14 in the tray 12a, and a cover 16 removably attached to the tray 12a. The tray 12a has a base portion 40 and a plurality of cup portions 42. While the cup portions 42 are illustrated as being cylindrically shaped, it will be understood that any of the shapes described in conjunction with the tray 12, or combination of shapes may be used.

The packaged food product 10a may further comprise one or more of the handle 38 for the food product 14. In one embodiment, the one or more handle 38 may be inserted into the food product 14 in one or more of the cup portions 42 through the cover 16 before the food product 14 is frozen. Once the food product 14 is frozen, the food product 14 may be discharged from the tray 12a through the cover 16 and the handle 38 may be used to hold the food product 14 for consumption. Though the handle 38 is illustrated as a planar member, it will be understood that the handle 38 may be of any suitable shape.

Referring to FIGS. 1-7, forming the packaged food products 10, 10a may comprise adding one or more freezable food product 14 to the cup portions 22, 42 of the tray 12, 12a and attaching a cover 16 to the base portion 20, 40, such that, when frozen, the food product 14 is dischargeable from the cup portions 22, 42 through the cover 16 when force is applied to deform the cup portions 22, 42.

As illustrated in FIG. 8, a plurality of the packaged food products 10, 10a may be packaged for shipment and/or storage. The trays 12, 12a of the packaged food products 10, 10a may be stackable or matingly engageable for ease of packaging, storing, and shipping of the packaged food products 10, 10a, such as in box 50.

In use, a user may obtain the packaged food product 10, 10a. The user may cool the packaged food product 10, 10a until the food product 14 is frozen. The user may then apply force to one or more of the cup portions 22, 42 to discharge the food product 14 from the cup portion 22, 42. The discharged food product 14 may then be consumed.

Additionally or alternately, the user may remove the cover 16 as a single piece from one or more of the openings 24 of the cup portions 22, 42 of the tray 12, 12a, remove the food product 14 from the openings 24 from which the cover 16 is removed, and then consume the removed food product 14.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and/or as defined in the appended claims.

1. A packaged food product, comprising:
a tray having a base portion and a plurality of spaced-apart deformable cup portions each having an opening through the base portion;
a cover covering the openings of the cup portions and removably attached to the base portion, the cover rendable at each opening; and
one or more freezable food product contained in the cup portions such that, when frozen, the food product is dischargeable from the cup portions through the cover when force is applied to deform the cup portions.

2. The packaged food product of claim 1, wherein the cover is removable from the base portion as a single piece.

3. The packaged food product of claim 1, wherein the food product in a particular cup portion has a size of substantially a predetermined serving size of a food group.

4. The packaged food product of claim 1, wherein the plurality of cup portions is at least ten cup portions.

5. The packaged food product of claim 1, wherein the cover is aluminum foil.

6. The packaged food product of claim 1, wherein the cover is plastic.

7. The packaged food product of claim 1, wherein the cover is scored at each cup portion.

8. The packaged food product of claim 1, wherein the cover has a first thickness at each cup portion and a second thickness at the base portion, the second thickness thicker than the first thickness.

9. The packaged food product of claim 1, wherein the freezable food product is shelf-stable when unfrozen.

10. The packaged food product of claim 1, wherein the freezable food product is one or more food product selected from the group consisting of a puree, a yogurt, and a juice.

11. The packaged food product of claim 1, wherein the cup portions have a shape resembling one or more fruit such that when the food product is frozen the food product has a shape resembling the one or more fruit.

12. The packaged food product of claim 1, wherein the cup portions have a shape resembling one or more vegetable such that when the food product is frozen the food product has a shape resembling the one or more vegetable.

13. The packaged food product of claim 1, wherein the cup portions have a shape resembling one or more meat such that when the food product is frozen the food product has a shape resembling the one or more meat.

14. The packaged food product of claim 1, wherein the cup portions have a shape resembling one or more animal such that when the food product is frozen the food product has a shape resembling the one or more animal.

15. The packaged food product of claim 1, further comprising one or more handle insertable into the food product contained in the cup portions.

16. The packaged food product of claim 1, wherein each cup portion has a bottom and a sidewall extending from the bottom of the cup portion to the base portion of the tray so as to cooperate to define a pouch for containing the food product, such that the food product, when frozen, is dischargeable from the cup portion through the cover when force is applied to the bottom of the cup portion to deform the bottom of the cup portion toward the base portion of the tray.

17. The packaged food product of claim 1, wherein the food product contained in a single cup portion contains protein of an amount predetermined as a serving size.

18. The packaged food product of claim 1, wherein the base portion is made of a first material and the cup portions are made of a second material, the first material different from the second material.

19. A method of forming a packaged food product, comprising:
placing one or more freezable food product in a tray having a base portion and a plurality of spaced-apart deformable cup portions each having an opening through the base portion, the freezable food product placed in the cup portions; and
attaching a cover to the base portion, the cover covering the openings of the cup portions and removably attached to the base portion, the cover rendable at each opening, such that, when frozen, the food product is dischargeable from the cup portions through the cover when force is applied to deform the cup portions.

20. A method of consuming a packaged food product, comprising:
obtaining a packaged food product wherein the packaged food product is selected from the group consisting of those claimed in any one of claim 1 to claim 18, comprising:
freezing the food product in the tray;
applying force to at least one of the cup portions to discharge the food product from the at least one cup portions; and
consuming the discharged food product.
